(19) United States
(12) Patent Application Publication
(10) Pub. No.: US 2025/0115731 A1
(43) Pub. Date: Apr. 10, 2025

(54) METHOD FOR PREPARING POLYESTER MODIFIED MATERIAL FROM RECYCLED RELEASE FILM

(71) Applicant: NAN YA PLASTICS CORPORATION, Taipei City (TW)

(72) Inventors: Te-Chao Liao, Taipei City (TW); Wen-Cheng Yang, Taipei City (TW); Chun-Che Tsao, Taipei City (TW); Chia-Yen Hsiao, Taipei City (TW); Yueh-Shin Liu, Taipei City (TW)

(73) Assignee: NAN YA PLASTICS CORPORATION, Taipei City (TW)

(21) Appl. No.: 18/502,099

(22) Filed: Nov. 6, 2023

(30) Foreign Application Priority Data
Oct. 4, 2023 (TW) 112137991

(51) Int. Cl. C08J 11/12

(52) U.S. Cl. CPC C08J 11/12; C08J 2367/02

(57) ABSTRACT

A method for preparing a polyester modified material from a recycled release film includes continuously performing the following steps at an elevated temperature: subjecting the recycled release film to a first melting treatment to form a low-viscosity polyester; subjecting the low-viscosity polyester to a polymerization treatment to form a high-viscosity polyester, wherein a viscosity of the high-viscosity polyester is greater than a viscosity of the low-viscosity polyester; and adding a modifier to the high-viscosity polyester to perform a second melting treatment to form the polyester modified material.

### CROSS-REFERENCE TO RELATED APPLICATION

This application claims the priority benefit of Taiwan application serial no. 112137991, filed on Oct. 4, 2023. The entirety of the above-mentioned patent application is hereby incorporated by reference herein and made a part of this specification.

### BACKGROUND

### Technical Field

The disclosure relates to a method for treating a recycled release film, and in particular to a method for preparing a polyester modified material from a recycled release film.

### Description of Related Art

A release film involves coating a release agent on a polyester (e.g., polyethylene terephthalate (PET)) film to render the surface of the release film separable for setting apart a viscous material and has been widely applied in packaging, laminating, circuit boards, adhesive products, insulation products, etc. In response to worldwide enterprise carbon reduction and environmental protection, social responsibility, and environmental, social, and governance (ESG) policy, the market is gradually leaning toward circular economy and plastic recycling for reuse. Under the premise that processability remains unaffected, introduction of environmentally friendly recycled materials of low carbon emission helps achieve global plastic reduction and energy conservation goals. Hence, by recycling the polyester material in the release film and forming a functional modified material for reuse, enterprise carbon reduction policy is duly followed and application value of recycled polyester materials is also enhanced.

Currently, preparing a polyester modified material from a recycled release film is through a stage-by-stage manufacturing process, which generally includes a first-stage process of pulverizing, melting, and extruding a material for manufacturing solid-state ester particles; a second-stage process of elevating the temperature of the solid-state ester particles for solid-state polymerization to form high-viscosity ester particles; and a third-stage process of subjecting the high-viscosity polyester particles to melting at an elevated temperature for modification. However, repetitive temperature elevating and lowering procedures drastically increase energy usage, so carbon emission cannot be effectively reduced.

In light of the foregoing, a critical issue for present research is developing a method that can effectively reduce carbon emission of preparing the polyester modified material from the recycled release film.

### SUMMARY

The disclosure provides a method for preparing a polyester modified material from a recycled release film for reducing carbon emission.

The method for preparing the polyester modified material from the recycled release film of the disclosure includes continuously performing the following steps at an elevated temperature. The recycled release film is subjected to a first melting treatment to form a low-viscosity polyester. The low-viscosity polyester is subjected to a polymerization treatment to form a high-viscosity polyester. A viscosity of the high-viscosity polyester is greater than a viscosity of the low-viscosity polyester. A modifier is added to the high-viscosity polyester to perform a second melting treatment to form the polyester modified material.

In an embodiment of the disclosure, the elevated temperature is 230° C. to 300° C.

In an embodiment of the disclosure, a temperature of the first melting treatment is 240° C. to 290° C.

In an embodiment of the disclosure, an intrinsic viscosity of the low-viscosity polyester is 0.5 dL/g to 0.62 dL/g.

In an embodiment of the disclosure, the method further includes subjecting the recycled release film to a surface coating scraping treatment before the first melting treatment.

In an embodiment of the disclosure, the method further includes filtering the low-viscosity polyester after the first melting treatment.

In an embodiment of the disclosure, the polymerization treatment includes liquid-state thickening.

In an embodiment of the disclosure, an intrinsic viscosity of the high-viscosity polyester is 0.7 dL/g to 0.86 dL/g.

In an embodiment of the disclosure, the modifier includes a glass fiber, a flame retardant, a toughening agent, a nucleating agent, a weather-resistant modifier, an antioxidant, and/or a lubricant.

In an embodiment of the disclosure, a temperature of the second melting treatment is 240° C. to 275° C.

In an embodiment of the disclosure, the high-viscosity polyester includes polyethylene terephthalate of more than 99% purity.

In an embodiment of the disclosure, the method further includes subjecting the polyester modified material to a granulation treatment after the second melting treatment to form polyester modified particles.

In light of the foregoing, the method for preparing the polyester modified material from the recycled release film enables polymerization and modification treatment to be performed in a continuous melting state at a stable elevated temperature, which can prevent energy consumption caused by repetitive temperature elevating and lowering, further effectively reducing carbon emission.

### BRIEF DESCRIPTION OF THE DRAWINGS

FIG. 1s a flowchart illustrating a method for preparing a polyester modified material from a recycled release film according to an embodiment of the disclosure.

### DESCRIPTION OF THE EMBODIMENTS

Embodiments of the disclosure are elaborated on as follows. However, the embodiments are exemplary and do not limit the scope of this disclosure.

In the text herein, a range indicated by “from a numeric value to another numeric value” signifies a general expression for avoiding listing all numeric values one by one in this specification. Hence, description of a certain numeric value range covers any numeric value within the numeric range and a smaller numeric range defined by any numeric values within the numeric range, which is equivalent to specifying the numeric values and the smaller numeric range.

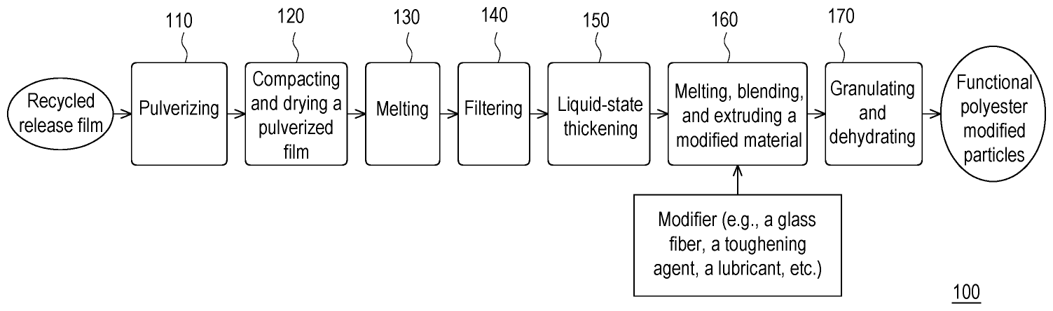

FIG. 1 is a flowchart illustrating a method 100 for preparing a polyester modified material from a recycled release film according to an embodiment of the disclosure. Please refer to FIG. 1. Firstly, in step 110, the recycled release film obtained may be pulverized to acquire a pulverized film. In some embodiments, the recycled release film may come from a circuit board, a protection film of an optical product, a multi-layer ceramic capacitor release film, and a ceramic substrate release film. In some embodiments, the recycled release film may be a release film manufactured by Nan Ya Plastics Corporation. In some embodiments, the recycled release film may include a polyester base material and a coating or a slurry (e.g., a ceramic coating or slurry) coated on the surface of the polyester base material. In some embodiments, the polyester base material may include polyethylene terephthalate (PET). In some embodiments, the coating or the slurry coated on the surface of the polyester base material may include a release agent or the ceramic slurry. In some embodiments, the release agent may include a silicon release agent and/or a fluorine release agent. In some embodiments, before pulverizing the recycled release film, the coating or the slurry on the surface of the recycled release film may be scraped in advance to prevent affecting color hue and properties of the subsequently generated polyester modified material.

For example, pulverizing the release film may be performed in a physical manner, such as forming the pulverized film by mechanically pulverizing or mechanically cutting the recycled release film or forming a shredded recycled material. In other words, in comparison with the recycled release film, the shredded recycled material may be smaller in size. For example, the recycled release film may be in a flake or film form while the shredded recycled material may be in a block, micro-flake, powder, or granular form.

Next, in step 120, compaction and drying may be performed on the pulverized film generated from pulverizing the recycled release film. Drying is to prevent moisture from causing over-degradation during a polyester recycling manufacturing process. Drying may be further performed on the shredded recycled material through heating or low-pressure placement, but the disclosure is not limited thereto. For another example, the previously mentioned treatment on the pulverized films may include a corresponding compaction treatment, but the disclosure is not limited thereto. The compaction treatment can reduce the volume of the shredded recycled material when subjected to a first melting treatment to improve manufacturing process efficiency.

Subsequently, step 130 to step 160 may be continuously performed at an elevated temperature. In this way, substantial energy consumption caused by repetitive temperature elevating and lowering can be prevented. In some embodiments, the elevated temperature is approximately 230° C. to 300° C., such as 230° C. to 290° C., 240° C. to 300° C., or 240° C. to 290° C., but the disclosure is not limited thereto. In some embodiments, the elevated temperature is approximately 250° C. to 270° C., 255° C. to 275° C., or 260° C. to 280° C. In some embodiments, the elevated temperature is approximately 245° C., 265° C., or 285° C.

In some embodiments, in step 130, the first melting treatment may be performed in advance on the compacted and dried pulverized film to form a low-viscosity polyester. In some embodiments, the first melting treatment is performed at a temperature of approximately 240° C. to 290° C., such as at 260° C., 270° C., or 280° C. For example, through a melting and extrusion step, the shredded recycled material is melted to form the low-viscosity polyester. The shredded recycled material may be, for example, placed into an extrusion apparatus. The extrusion apparatus may include, for example, a single screw extruder (SSE), a twin screw extruder (TSE), or other similar screw extruders. The extrusion apparatus may melt the shredded recycled material to form the low-viscosity polyester in a melting state. In the embodiment, the shredded recycled material in the extrusion apparatus may be heated to approximately 240° C. to 290° C. That is to say, the temperature of the first melting treatment may be approximately 240° C. to 290° C. In some embodiments, a duration of the first melting treatment is approximately 2 minutes to 10 minutes, such as 4 minutes, 6 minutes, or 8 minutes. In some embodiments, an intrinsic viscosity of the low-viscosity polyester is approximately 0.5 dL/g to 0.62 dL/g, such as 0.53 dL/g, 0.57 dL/g, or 0.6 dL/g.

Next, in step 140, the low-viscosity polyester in the melting state may be filtered by a filter mesh to remove solid-state impurities from the low-viscosity polyester. In some embodiments, the filtration may be performed at a temperature of approximately between 240° C. and 290° C.

Next, in step 150, the low-viscosity polyester may be subjected to a polymerization treatment to form a high-viscosity polyester, so that a viscosity of the high-viscosity polyester is greater than a viscosity of the low-viscosity polyester. In some embodiments, the polymerization treatment includes liquid-state thickening of the low-viscosity polyester in the extrusion apparatus.

In some embodiments, an intrinsic viscosity of the high-viscosity polyester is approximately 0.7 dL/g to 0.86 dL/g, such as 0.75 dL/g, 0.8 dL/g, or 0.85 dL/g. For example, in the embodiment, the low-viscosity polyester in the extrusion apparatus may be heated to approximately 240° C. to 290° C., and a duration of the heating may be approximately 15 minutes to 60 minutes, such as 25 minutes, 40 minutes, or 55 minutes. Therefore, the intrinsic viscosity of the low-viscosity polyester may be increased.

In some embodiments, the low-viscosity polyester placed inside the extrusion apparatus may be subjected to an air pressure reduction step to more easily discharge air in the shredded recycled material (such as air between the shredded recycled material in the slice, powder, or particle form) and/or to more easily discharge volatile substance in the shredded recycled material. Therefore, the intrinsic viscosity of the low-viscosity polyester may be increased. In some embodiments, the air pressure reduction step may reduce the air pressure to 1 mbar to 6 mbar, such as 2 mbar, 3 mbar, or 5 mbar, and a duration of the air pressure reduction step may be 15 minutes to 60 minutes, such as 20 minutes, 35 minutes, or 50 minutes.

In an embodiment, the low-viscosity polyester placed inside the extrusion apparatus may be heated to approximately 260° C. to 270° C. and the air pressure may be reduced to approximately 5 mbar. A duration of heating to the temperature and reducing to the air pressure may be approximately 15 minutes to 20 minutes. Consequently, if the intrinsic viscosity of the low-viscosity polyester is approximately 0.5 dL/g, an intrinsic viscosity of the generated high-viscosity polyester may be approximately 0.72 dL/g.

In an embodiment, the low-viscosity polyester placed inside the extrusion apparatus may be heated to approximately 260° C. to 270° C. and the air pressure may be reduced to approximately 5 mbar. A duration of heating to the temperature and reducing to the air pressure may be approximately 30 minutes to 40 minutes. Consequently, if the intrinsic viscosity of the low-viscosity polyester is approximately 0.5 dL/g, an intrinsic viscosity of the generated high-viscosity polyester may be approximately 0.85 dL/g.

In an embodiment, the low-viscosity polyester placed inside the extrusion apparatus may be heated to approximately 260° C. to 270° C. and the air pressure may be reduced to 2 mbar. A duration of heating to the temperature and reducing to the air pressure may be approximately 30 minutes to 40 minutes. Consequently, if the intrinsic viscosity of the low-viscosity polyester is 0.5 dL/g, an intrinsic viscosity of the generated high-viscosity polyester may be approximately 0.75 dL/g.

In some embodiments, when the polyester base material of the recycled release film includes polyethylene terephthalate (PET), the high-viscosity polyester includes polyethylene terephthalate of more than 99% purity, but the disclosure is not limited thereto.

Next, in step 160, a modifier may be added to the high-viscosity polyester for a second melting treatment to subject the high-viscosity polyester to a modification treatment, so as to form various functional polyester modified materials. In some embodiments, the modifier includes a glass fiber, a flame retardant, a toughening agent, a nucleating agent, a weather-resistant modifier, an antioxidant, and/or a lubricant. In some embodiments, the temperature of the second melting treatment is approximately 240° C. to 275° C., such as 250° C., 260° C., or 270° C. In some embodiments, a duration of the second melting treatment is 1 minute to 10 minutes, such as 3 minutes, 5 minutes, or 7 minutes.

For example, an extruder used for extrusion modification of the second melting treatment is a commercially available twin screw extruder (TSE) or other similar screw extruders, but the disclosure is not limited thereto. In the disclosure, the structure and/or operation of the commercially available extruder is not specified in detail.

In an embodiment, at least one feeder (e.g., a side feeder) may be attached to the extruder. The feeder may be a loss-in-weight feeder equipped with a loss-in-weight meter. The feeder may also be a conventional commercially available apparatus and/or an optional add-on. That is to say, each component of the polyester mixture may be mixed before feeding or upon feeding, or fed into the extruder by different feeders to be mixed inside the extruder. In some embodiments, the extruder may be connected to an air-extraction system. The air-extraction system may include a conventional air-extraction pump and a corresponding air pipeline. The extruder may vent-up or enhance vent-up efficiency by the air-extraction system.

In some embodiments, when the modifier is the glass fiber, a glass-fiber reinforced polyester modified material that is impact-resistant may be generated. In some embodiments, when the modifier is the flame retardant, a flame retardant polyester modified material may be generated. In some embodiments, when the modifier is the toughening agent, a high-viscosity polyester modified material for profile extrusion may be generated. In some embodiments, when the modifier is the lubricant, a polyester modified material of better release performance may be generated. In some embodiments, when the modifier is polycarbonate (PC) or acrylonitrile butadiene styrene (ABS) resin, or a compatible modifier, a polyester alloy modified material may be generated. In some embodiments, when the modifier is the nucleating agent, the weather-resistant modifier, or the antioxidant, a polyester modified material that has nucleating, weather-resistant, or antioxidant performance respectively may be generated.

Subsequently, in step 170, the functional polyester modified material may be subjected to a granulation treatment to form functional polyester modified particles. In some embodiments, the granulation treatment involves extruding the polyester modified material into strips, cooling and curing the strips in a bath tank, and granulating through a cutter to form the polyester modified particles. In some embodiments, a dehydration treatment may be also performed during the granulation treatment to remove water adhering to the polyester modified particles during granulation.

In summary, the method for preparing the polyester modified material from the recycled release film of this disclosure involves polymerization and modification treatment in a continuous melting state, and a stable elevated temperature is maintained during the treatment. In comparison with a conventional stage-by-stage manufacturing process of repetitive temperature elevating and lowering, more energy can be saved, so carbon emission reduction can be effectively accomplished, thereby enhancing the application value of the recycled polyester material.

What is claimed is:

1. A method for preparing a polyester modified material from a recycled release film, comprising:
continuously performing following steps at an elevated temperature:
subjecting the recycled release film to a first melting treatment to form a low-viscosity polyester;
subjecting the low-viscosity polyester to a polymerization treatment to form a high-viscosity polyester, wherein a viscosity of the high-viscosity polyester is greater than a viscosity of the low-viscosity polyester; and
adding a modifier to the high-viscosity polyester to perform a second melting treatment to form the polyester modified material.

2. The method according to claim 1, wherein the elevated temperature is 230° C. to 300° C.

3. The method according to claim 1, wherein a temperature of the first melting treatment is 240° C. to 290° C.

4. The method according to claim 1, wherein an intrinsic viscosity of the low-viscosity polyester is 0.5 dL/g to 0.62 dL/g.

5. The method according to claim 1, further comprising performing surface coating scraping on the recycled release film before the first melting treatment.

6. The method according to claim 1, further comprising filtering the low-viscosity polyester after the first melting treatment.

7. The method according to claim 1, wherein the polymerization treatment comprises liquid-state thickening.

8. The method according to claim 1, wherein an intrinsic viscosity of the high-viscosity polyester is 0.7 dL/g to 0.86 dL/g.

9. The method according to claim 1, wherein the modifier comprises a glass fiber, a flame retardant, a toughening agent, a nucleating agent, a weather-resistant modifier, an antioxidant, and/or a lubricant.

10. The method according to claim 1, wherein a temperature of the second melting treatment is 240° C. to 275° C.

11. The method according to claim 1, wherein the high-viscosity polyester comprises polyethylene terephthalate of more than 99% purity.

12. The method according to claim 1, further comprising subjecting the polyester modified material to a granulation treatment after the second melting treatment to form polyester modified particles.
